(19) United States
(12) Patent Application Publication
(10) Pub. No.: US 2007/0237878 A1
(43) Pub. Date: Oct. 11, 2007

(54) Product containing vegetable oil and dispensing article

(75) Inventors: Rosemary Antoinette Golden, Franklin Park, NJ (US); Pallav Shah, Clifton, NJ (US)

Correspondence Address: UNILEVER INTELLECTUAL PROPERTY GROUP, 700 SYLVAN AVENUE,, BLDG C2 SOUTH, ENGLEWOOD CLIFFS, NJ, 07632-3100, US

(73) Assignee: Conopco, Inc., d/b/a Unilever

(21) Appl. No.: 11/399,763

(22) Filed: Apr. 7, 2006

(51) Int. Cl. A23D 9/00

(52) U.S. Cl. 426/601

(57) ABSTRACT

A food product including a liquid edible vegetable oil containing composition and dispensing article is provided. The article includes a reservoir for receiving a liquid composition and an operating unit for dispensing the vegetable oil containing composition as a spray. The operating unit is in fluid communication with and positioned above the reservoir fitting by way of a suitable seal over an open end of the reservoir. The unit includes a button positioned concentrically above a shroud, and a mechanical liquid pump mechanism. The pump includes a body having an upper end and a lower end, having inner walls. The upper end is surrounded by a collar. A piston, movable within the body, is seated within collar and is movable therein. The piston is provided at its bottom end with a piston base and a gasket positioned between them. The piston base is positioned at its lower end adjacent a spring system. The spring system functions to return the piston of the liquid pump to an un-activated position. A liner device is inserted to concentrically surround the body at the bottom of the piston so as to restrict liquid composition flow through the vents and between the piston and the collar. Substantially no liquid drip is achieved with the mechanical pump mechanism in combination with the vegetable oil composition of the product.

### BACKGROUND OF THE INVENTION

1. Field of the Invention

A product containing vegetable oil and hand-held spray dispensing article based on a non-aerosol mechanical liquid pump device.

2. The Related Art

Vegetable oil containing compositions are useful in a variety of consumer food products. These include compositions intended as liquid salad dressings or flavorings, for example. Non-aerosol spray devices including pump assemblies can be useful for dispensing vegetable oil containing compositions.

A variety of pump devices have been on the market for several years, such as the SeaBreeze™ pump available from the SeaquistPerfect Dispensing Company for example. Mechanical pumps are disclosed in U.S. Pat. No. 5,642,860 and Grogan U.S. Pat. No. 5,738,282, as a further background.

Rainey et al., U.S. Pat. No. 6,113,970 discloses a lecithin based spray product. An article found at www.prnewsnow.com on or about Aug. 23, 2005, entitled “The flavor Spray Diet Is Open For Business,” PR News Now: News at the Speed of Now, describes a flavoring spray product containing no fat and no calories. See also, www.flavorspraydiet.com (cited in the aforementioned article).

Certain shortcomings in the commercially available mechanical pump devices when they are applied for delivering compositions containing vegetable oil have been found. Unwittingly consumers would operate pumps of the aforementioned type in a manner causing various problems. Slow downward pressure on the actuator head increases chances of a slow return for valve closure of the liquid product containment chamber. A tilt or shaking of the package then allows liquid to enter the vent in the body and travel past the piston into the well of the shroud. Once within the well, some liquid product will be trapped. Especially when shaken, the trapped product in the well of the shroud travels out of the gap between the button and the shroud. As a consequence, liquid product can dribble from the vicinity of the exit nozzle rather than being expressed as a spray.

Accordingly, it would be desirable to have an improved mechanical pump system that avoids the expression of vegetable oil containing liquid product.

### SUMMARY OF THE INVENTION

A food product is described, comprised of a vegetable oil containing composition and a hand-held dispensing article based on a non-aerosol mechanical pump. The product includes a liquid food composition comprising at least about 5% liquid vegetable oil, and may consist essentially of less than about 70% vegetable oil by weight, water and acidifier. The vegetable oil content in said composition is preferably about 5% to about 70% by weight, and more preferably, about 5% to about 25% by weight. The vegetable oil composition is substantially lecithin free and non-emulsified. The food product further includes a hand-held spray dispensing article comprising: a reservoir for receiving a liquid composition, the reservoir having a closed and an open end; an operating unit for dispensing the spray at least partially positioned over the reservoir at the open end, whereby said operating unit is in fluid communication with said reservoir, the unit comprising a button positioned concentrically above a shroud and a discharge outlet downstream, the operating unit being downwardly movable toward the reservoir by hand pressure; and a closure attachable to said open end of said reservoir by suitable means; said closure extending upwardly from said open end and terminating in a nozzle head.

A liquid pump assembly is positioned at least partially below the operating unit. The pump assembly includes a body 12 having an upper end 46 and a lower end 47 of smaller cross-sectional diameter that upper end 46. Upper end 46 is surrounded by collar 13. Lower end has inner walls 48. A piston 22 movable within body 12 is seated within collar 13 and is movable therein. The piston is movable in sliding engagement within the body, together with a gasket, and a piston base positioned at a lower end of the piston.

A spring system is positioned below the piston base and atop a ball valve; with the ball valve seated atop a tube at the inlet of the liquid pump which extends downward into the reservoir. The spring system functions to return the liquid pump piston upward to an un-activated position. The spring system comprises a spring of cylindrical spiral configuration. The article further includes a liquid inlet at the tube; a discharge orifice including an orifice cup and terminating in a spray nozzle. The orifice cup is variable in size. A liner device is inserted to concentrically surround the body at the bottom of the piston so as to restrict liquid composition flow through the vents and between the piston and the collar.

The operating unit is downwardly movable toward the reservoir by hand pressure, thereby forcing the piston, the gasket and the piston base to move downwardly, thereby pumping the liquid composition. The article does not leak and shows no sign of leakage between the piston and the collar.

### BRIEF DESCRIPTION OF THE DRAWINGS

Further features and advantages of the present invention are described in the accompaning drawings in which:

FIG. 1 illustrates a sectional perspective view of a product according to the present invention including dispensing article for the vegetable oil containing composition;

FIG. 2 illustrates an enlarged sectional view of the pump mechanism as boxed and labeled “FIG. 2” in the article of FIG. 1.

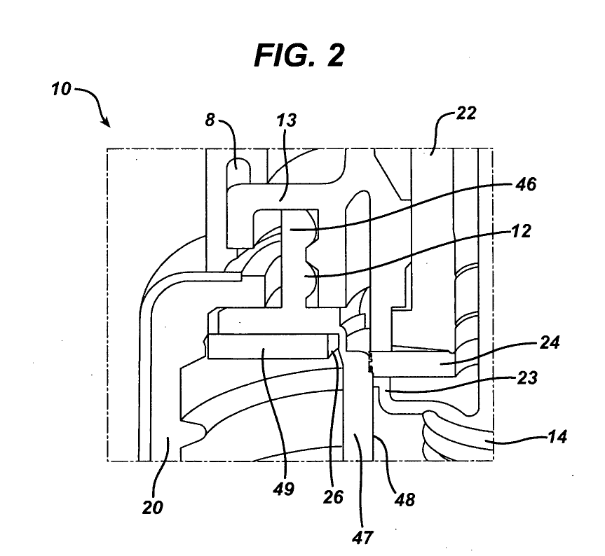

### DETAILED DESCRIPTION OF THE INVENTION

The present invention is based in part on, although not limited to, the discovery that consumers prefer a non-aerosol spray dispensing article for salad dressing compositions. Problems have been recognized with certain standard mechanical pumps when used in combination with vegetable oil containing compositions, particularly with non-emulsified compositions containing liquid vegetable oil. These types of pumps often cause liquid products to drip because liquid can bypass the piston. Without wishing to be bound by theory, it is believed that the leakage is particularly caused by the oil in the composition, which settles on top of the aqueous phase of the non-emulsified product. Now it has been found that product can be improved by insertion of a liner in the pump assembly.

To improve the pump system functioning, an annular liner, lodged within a cylinder of the pump concentrically surrounding the body of the pump at the vents, can avoid product leakage between the button and shroud area. The liner restricts the flow of the vegetable oil containing composition through the vents without restricting the flow of air into the bottle. The liner may be made of any soft plastic material, such as foam, preferably polyethylene foam.

According to the present invention, a non-aerosol (as particularly preferred by consumers) hand-held liquid product spray dispensing article 1 includes a reservoir 2 for receiving a liquid vegetable oil containing composition 4 and an operating unit 6 for dispensing liquid composition 4 as a spray.

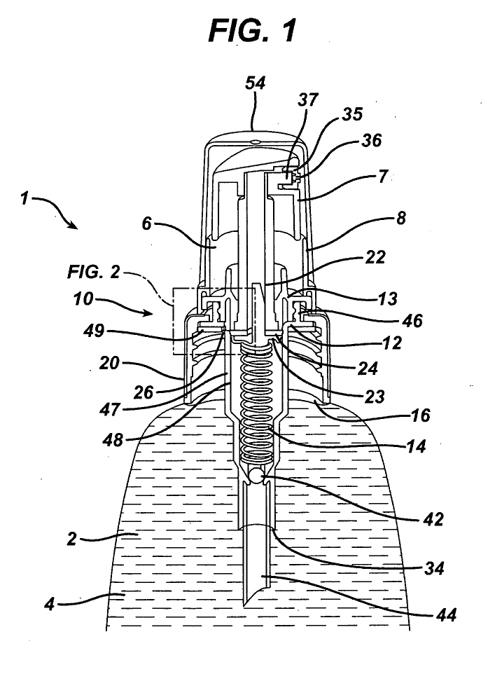

FIG. 1 illustrates a perspective cut-away of a product of the present invention including dispensing article 1 intended for the vegetable oil containing composition 4. Operating unit 6 is in fluid communication with and positioned above reservoir 2 fitting by way of a suitable seal over an open end 16 of reservoir 2. Opposite open end 16 is a closed end 18 (not shown) serving as a bottom of reservoir 2. A closure 20 attaches to the mouth or open end 16 of reservoir 2 by suitable means, such as by screw and thread mating. Closure 20 extends upwardly from open end 16 and terminates in nozzle head 54.

Unit 6 includes a button 7 positioned concentrically above a shroud 8, and a mechanical liquid pump mechanism 10. Pump mechanism 10 includes a body 12 having an upper end 46 and a lower end 47 of smaller cross-sectional diameter that upper end 46. Upper end 46 is surrounded by collar 13. Lower end has inner walls 48. A piston 22 movable within body 12 is seated within collar 13 and is movable therein. Piston 22 is provided at its bottom end with a piston base 23 and a gasket 24 positioned between them. Piston base 23 is positioned at its lower end adjacent spring 14. Spring 14 is of cylindrical spiral configuration, is seated atop a ball valve 42 and rests against inner walls 48 of body 12 and is positioned directly under piston base 23. Ball valve 42 is seated atop a tube 44 which extends downward into reservoir 2.

Vents 26 are formed in body 12 at the bottom of piston 22. A liner 49 is provided to concentrically surround body 12 at the bottom of piston 22 so as to restrict the flow of composition 4 through vents 26 without restricting the flow of air into reservoir 2.

Liquid pump 10 further includes a liquid inlet 34 and a discharge outlet 36 through which composition 4 exits the dispensing article 1. Discharge outlet 36 is formed in a spray nozzle 35 which is the terminal part of an orifice cup 37. Orifice cup 37 may be made of any rigid plastic material, such as acetal.

Spring system 14 is provided with a spring of cylindrical spiral configuration. Spring 14 rests against inner walls 48 of body 12 and is positioned directly under piston base 23.

In Use. Operation of dispensing article 1 occurs in the following manner. Article 1 with vegetable oil composition 4 is held by hand while downward pressure is applied against nozzle head 54 to dispense the composition 4 by a spraying mechanism. By application of hand pressure against nozzle head 54, body 12 is downwardly movable toward reservoir 2 by way of button 7. Thereby, on the down-stroke, piston 22 is forced to pump liquid composition 4 upwardly through tube 44.

As can be seen in FIG. 1, the actuation movement forces piston 22, gasket 24, and piston base 23 to slide downward within body 12 of liquid pump assembly 10. Concurrently compressed through the downward stroke is spring 14 lodged between piston base 23 and ball valve 42.

Once downward pressure on nozzle head 54 is released, spring 14 forces a return stroke. Ball valve 42 opens allowing liquid composition 4 to be suctioned up through tube 44. Tube 44 draws liquid composition 4 from bottom 18 of reservoir 2 to an area directly below ball valve 42. It is transported through body 12 and toward orifice cup 37, where the fluid collects prior to discharge through nozzle 35. Therein, liquid composition 4 exits through discharge outlet 36. Concurrently the return stroke allows air to reenter the pump system through vent 26 and bringing the pressure above liquid composition 4 in reservoir 2 back to atmospheric.

A salad dressing composition 4 may require several actuations to suitably cover a salad. The consumer wants to limit the number of actuations to a reasonable work load. Preferably, the number of actuations is about 10.

Composition. Liquid vegetable oil containing composition 4 preferably is a food product, such as, for example, a salad dressing. Ingredients of these liquid, non-emulsified, products include edible vegetable oil, water, and food grade acids such as citric acid or acetic acid. Further ingredients may include, but are not limited to, preservatives, flavors, fragrances, thickeners, sugar, and salt. Essentially no lecithin is employed in the compositions with one advantage of avoiding the cost thereof, and another advantage of the pump being non-aerosol as preferred by consumers, and therefore not requiring lecithin.

The vegetable oils can be any food grade liquid oil, including but not limited to soybean oil, olive oil, canola oil, corn oil, sunflower seed oil, and rapeseed oil. The vegetable oils may be saturated or unsaturated, however, non-hydrogenated oils are preferred. The amount of vegetable oil may range anywhere from about 0.1 to about 70%, preferably, about 1 to about 50%; more preferably, about 3 to about 30%; and most preferably from about 5 to about 20% by weight of the liquid product. Particularly advantageous for use according to the present invention are compositions containing a minimum of 5% by weight oil, as the leakage problem in the absence of the invention is, without wishing to be bound by theory, believed to become more and more pronounced at higher oil levels.

The viscosity of the compositions may be adjusted to suit a particular product and to work with a particular dispenser variation. The viscosity of the compositions may range from about 100 to about 1000 cps as measured on the Brookfield Viscometer, RVT, at room temperature and spindle speed of 110. Preferably, the viscosity ranges at about 150 cps to about 950 cps, most preferably, about 200 to about 600 cps for a vinaigrette type salad dressing composition.

Except in the operating and comparative examples, or where otherwise explicitly indicated, all numbers in this description indicating amounts of material ought to be understood as modified by the word “about”.

The term “comprising” is meant not to be limiting to any subsequently stated elements but rather to encompass non-specified elements of major or minor functional importance. In other words the listed steps, elements or options need not be exhaustive. Whenever the words “including” or “having” are used, these terms are meant to be equivalent to “comprising” as defined above.

### EXAMPLE 1

A study was conducted to evaluate the problem of leakage of a vegetable oil containing composition when sprayed from a dispenser. A commercial Seaquist pump model SeaBreeze was utilized in the study, with and without the liner 49. The liquid composition employed comprised soybean oil, water and a variety of minor ingredients, with an exemplary composition appearing in the Table below.

TABLE 1
BALSAMIC VINAIGRETTE SPRAY

| | FORMULA |
|---|---|
| | PERCENT |
| INGREDIENT | |
| WATER | BALANCE |
| HIGH FRUCTOSE CORN SYRUP 42 | 18.0000 |
| Defoamer | 0.0025 |
| SOYBEAN OIL | varies per Table 2 |
| Xanthan Gum e.g. Kelco/ISP | 0.2400 |
| FLAVORS e.g. IFF | 3.4500 |
| AQUARESIN BLACK PEPPER - 22-19-142 | 0.0110 |
| VINEGAR | 25.5000 |
| SORBIC ACID | 0.0800 |
| CALCIUM DISODIUM EDTA | 0.0070 |
| SALT | 4.0000 |
| TOTAL | 100.0000 |
| SPECIFICATIONS: | |
| PH | 2.75-2.95 |
| ACID | 1.57-1.87 |
| DENSITY | 1.074-1.104 G/ML |

The test method for measuring the liquid composition 4 leakage involved the following procedure. Three different, non-emulsified, compositions 4 with different oil levels in the salad dressing were tested. Sample pumps 10, with and without liner 49, not previously primed with any liquid, were purposefully shaken and/or inverted during the priming pumping action for evaluation. The Table below outlines the test parameters and results. It was found that 40% of the bottles tested, which were not equipped with liner 49, resulted in leakage for non-emulsified compositions 4 having 5% oil or more.

TABLE 2

| Oil Level | With Liner | No Liner |
|---|---|---|
| 3% | No Leakage | No Leakage |
| 5% | No Leakage | Leakage |
| 9% | No Leakage | Leakage |

### EXAMPLE 2

This experiment aimed to evaluate whether product leakage between the button 7 and shroud 8 area would occur under experimental conditions. Products according to the present invention, as set forth in Table 1 above, having about 10% vegetable oil in composition 4, and including liner 49 in pump assembly 10 were vacuum leak tested. 100% passed.

The following tests were performed:
Vacuum leak tested for 5 minutes at 800 mb—no leakage
Hydrostatic leak tested for 5 minutes—no leakage
Packages were shaken and sprayed—no leakage
Buttons 7 were removed and inspected for leakage—no leakage

No piston 22 leakage was observed with this modified pump. No leakage between piston 22 and collar 13 was observed. The aforementioned results indicate that a liner is necessary to avoid pump leakage.

While the present invention has been described herein with some specificity, and with reference to certain preferred embodiments thereof, those of ordinary skill in the art will recognize numerous variations, modifications and substitutions of that which has been described which can be made, and which are within the scope and spirit of the invention. It is intended that all of these modifications and variations be within the scope of the present invention as described and claimed herein, and that the invention be limited only by the scope of the claims which follow, and that such claims be interpreted as broadly as is reasonable. Throughout this application, various publications have been cited. The entireties of each of these publications are hereby incorporated by reference herein.

What is claimed is:

1. A food product comprised of a vegetable oil containing composition and a hand-held dispensing article based on a non-aerosol mechanical pump, said product comprising:
(A) a liquid food composition comprising at least about 5% liquid vegetable oil; and
(B) a hand-held spray dispensing article comprising:
a reservoir for receiving a liquid composition, the reservoir having a closed and an open end;
an operating unit for dispensing the spray at least partially positioned over the reservoir at the open end, whereby said operating unit is in fluid communication with said reservoir, the unit comprising a button positioned concentrically above a shroud and a discharge outlet downstream, the operating unit being downwardly movable toward the reservoir by hand pressure;
a closure attachable to said open end of said reservoir by suitable means; said closure extending upwardly from said open end and terminating in nozzle head;
a liquid pump assembly positioned at least partially below said operating unit; said pump assembly comprising a body having an upper end a a lower end of smaller cross-sectional diameter, and further having inner walls with vents formed therein and having an upper end surrounded by a collar and containing therein a piston movable in sliding engagement within the body, a gasket, and a piston base positioned at a lower end of said piston;
a spring system positioned below said piston base and atop a ball valve; said ball valve seated atop a tube at the inlet of the liquid pump which extends downward into said reservoir; said spring system functioning to return the liquid pump piston upward to an unactivated position; and
a liquid inlet at said tube;
an orifice cup comprising a spray nozzle having a discharge orifice therein;
wherein a liner device is inserted to concentrically surround said body at the bottom of said piston so as to restrict liquid composition flow through said vents and between said piston and said collar.

2. The food product according to claim 1 wherein said product is a salad dressing spray.

3. The article according to claim 1 wherein said composition is non-emulsified.

4. The article according to claim 1 wherein said vegetable oil content in said composition is about 5 % to about 70 % by weight.

5. The article according to claim 1 wherein said vegetable oil content in said composition is about 5 % to about 25 % by weight.

6. The article according to claim 1 wherein said vegetable oil composition is substantially lecithin free.

7. The article according to claim 1 wherein said vegetable oil composition consists essentially of less than about 70% vegetable oil by weight, water, and acidifier.

8. The article according to claim 1 wherein the operating unit is downwardly movable toward the reservoir by hand pressure, thereby forcing the piston, the gasket and the piston base to move downwardly, thereby pumping said liquid composition.

9. The article according to claim 1 wherein the spring system comprises a spring of cylindrical spiral configuration.

10. The article according to claim 1 wherein said orifice cup is variable in size.
